(19) United States
(12) Patent Application Publication
(10) Pub. No.: US 2020/0331653 A1
(43) Pub. Date: Oct. 22, 2020

(54) FOLDING BLANK FOR MAILER AND METHOD

(71) Applicant: Company Box LLC, Geneva, OH (US)

(72) Inventor: Louis G. DeJesus, Cornelius, NC (US)

(21) Appl. No.: 16/853,147

(22) Filed: Apr. 20, 2020

Related U.S. Application Data
(60) Provisional application No. 62/863,708, filed on Jun. 19, 2019.
(60) Provisional application No. 62/848,001, filed on May 15, 2019.
(60) Provisional application No. 62/836,257, filed on Apr. 19, 2019.

(51) Int. Cl. B65D 5/20; B65D 5/22; B65D 5/42; B65D 5/66; B31B 50/26; B31B 50/62

(52) U.S. Cl. CPC B65D 5/2076; B65D 5/22; B65D 5/4216; B31B 50/88; B31B 50/26; B31B 50/624; B65D 5/6629

(57) ABSTRACT

A folding blank has a main body. The main body has an inner surface and an outer surface. Only the outer surface has printing thereon. The main body further includes an outer lid that is configured to selectively move between an opened position and a closed position where a remainder of the folding blank has been folded into a box. The outer lid has an outer lid panel, a first outer lid wing panel, and a second outer lid wing panel. Each of the first outer lid wing panel and the second outer lid wing panel are configured to fold inwardly from an unfolded position to a folded position so that the inner surface of the first outer lid wing panel and the inner surface of the second outer lid wing panel are disposed adjacent to and facing the inner surface of the outer lid in the folded position.

### CROSS-REFERENCE TO RELATED APPLICATIONS

This application claims the benefit of U.S. Provisional Application No. 62/863,708, filed on Jun. 19, 2019, and U.S. Provisional Application No. 62/848,001, filed on May 15, 2019, and U.S. Provisional Application No. 62/836,257, filed on Apr. 19, 2019. The entire disclosures of the above applications are hereby incorporated herein by reference.

### FIELD

The present disclosure relates to a box and, more particularly, to a mailer box optimized for advertising.

### BACKGROUND

Boxes, and in particular mailers, for articles have great utility in numerous and diverse industries. In particular, boxes are often used to ship products. These boxes may be manufactured and distributed in a folding blank form, which can be conveniently stored on site.

Folding boxes are generally known in the art. For example, U.S. Pat. No. 4,856,709 to Axelsson et al. describes a folding box of cardboard or similar material, having a longitudinal joint and top and bottom end closures and sealing membranes attached to flaps of the end closures

While many of these folding blanks and folding boxes have achieved varying degrees of success, they have a number of short comings.

First, the inner surface and outer surface of mailers may need to be printed upon to be used as advertisements. This may result in additional manufacturing time and lead to wasted resources, such as ink.

Second, packaging tampering has become a growing concern among consumers. Undesirably, many of these mailers lack security measures to prevent tampering.

Third, opening a sealed mailer may be overly cumbersome and require the mailer to be cut open. This may exacerbate the opening process and potentially lead to harm from the cutting operation.

Fourth, sealing a mailer for transit may require additional resources to seal said mailer. For example, the mailer may be sealed with packaging tape. Undesirably, this may result in wasted time and resources.

Fifth, sometimes a mailer needs to be returned to its original sender, requiring the consumer to use resources to reseal the mailer.

There is a continuing need for a mailer and method for constructing the mailer that can have advertisements within the mailer without having to print advertisements on the inner surface of the mailer. Desirably, the mailer can be easily opened, sealed, and resealed, and militates against tampering.

### SUMMARY

In concordance with the instant disclosure, a mailer that can display advertisements on the inside without having to print on the inner surface of the mailer, and which is easy to open, seal, and reseal, and militates against tampering has been surprisingly discovered.

This disclosure deals primarily with folded boxes, such as mailers, from flat box blanks, most desirably blanks made of paperboard or corrugated cardboard.

In one embodiment, a folding blank for constructing a mailer has a main body. The main body has an inner surface and an outer surface. The inner surface has no printing thereon. The outer surface has printing thereon. The main body further includes an outer lid. The outer lid is configured to selectively move between an opened position and a closed position where a remainder of the folding blank has been folded into a box. The outer lid has an outer lid panel, a first outer lid wing panel, and a second outer lid wing panel. Each of the first outer lid wing panel and the second outer lid wing panel are configured to fold inwardly from an unfolded position to a folded position so that the inner surface of the first outer lid wing panel and the inner surface of the second outer lid wing panel are disposed adjacent to and facing the inner surface of the outer lid panel in the folded position. The outer surface of each of the first outer lid wing panel and the outer surface of the second outer lid wing panel is visible where the outer lid is in the opened position.

In another embodiment, a mailer has a folding blank that has been folded into a box. The folding blank includes a main body. The main body has an inner surface and an outer surface. The inner surface has not printing thereon. The outer surface has printing thereon. The main body further includes an outer lid. The outer lid is configured to selectively move between an opened position and a closed position. The outer lid has an outer lid panel, a first outer lid wing panel, and a second outer lid wing panel. Each of the first outer lid wing panel and the second outer lid wing panel folded inwardly from an unfolded position to a folded position so that the inner surface of the first outer lid panel and the inner surface of the second outer lid wing panel are disposed adjacent to and facing the inner surface of the outer lid panel in the folded position. The outer surface of each of the first outer lid wing panel and the outer surface of the second outer lid wing panel is visible where the outer lid is in the opened position.

In a further embodiment, a method for constructing a mailer includes the step of providing a folding blank with a main body. The main body has an inner surface and an outer surface. The inner surface has no printing thereon. The outer surface has printing thereon. The main body further includes an outer lid. The outer lid is configured to selectively move between an opened position and a closed position where a remainder of the folding blank has been folded into a box. The outer lid has an outer lid panel, a first outer lid wing panel, and a second outer lid wing panel. Each of the first outer lid wing panel and the second outer lid wing panel are configured to fold inwardly from an unfolded position to a folded position so that the inner surface of the first outer lid wing panel and the inner surface of the second outer lid wing panel are disposed adjacent to and facing the inner surface of the outer lid panel in the folded position. Then, folding the first outer lid wing panel and the second outer lid wing panel inwardly from the unfolded position to the folded position. Next, folding the remainder of the folding blank to form the box. The outer surface of each of the first outer lid wing panel and the outer surface of the second outer lid wing panel are visible where the outer lid is in the opening position.

In an exemplary embodiment, a packaging system has a main body that is adapted to be folded into a container or a “mailer.” The container may have a tamper evident structure adapted to militate against a third party from accessing the contents of the packaging system. In further embodiments, the main body may be adapted to have a product display disposed on each of an exterior surface and an interior surface of the assembled container.

In particular embodiments, the main body may be a foldable material such as corrugated cardboard or paper. However, other folded materials including plastic or composite materials, may also be chosen by one skilled in the art. The material of the main body is adapted to withstand the shipping process and is configured to protect the product where disposed therein. The material of the main body may also be configured to receive the product display. In a non-limiting example, the product display may be an ink, a label, or any other marking that is adapted to illustrate the product or related advertising.

In further embodiments, the main body may be provided as a box blank. Advantageously, the box blank is more convenient to store on site than pre-assembled boxes. The box blank may be manufactured to any suitable size, and it should be appreciated that sizes will vary based on the intended product. The box blank may be folded to fill orders, as desired.

In a most particular embodiment, for example, the box blank may be adapted to receive the product display on a single side of the box blank. In a further non-limiting example, the box blank, with the single side having the product display, may be folded into the container, where the product display may be disposed on the interior surface and the exterior surface of the container, where assembled. It should be appreciated that the display being printed on the single side of the box blank is more efficient than printing the product display on both sides of the box blank.

In a further example, fold lines may include linear creases formed in corrugated cardboard. The fold lines may be provided with folding portions that are one of compressed, perforated, and scored. The folding portions are illustrated by dashed lines. It should be appreciated that the compression, perforations, or scoring of the folding portions may overcome the natural rigidity of the corrugated cardboard and facilitate folding or tearing of the cardboard material.

In particular, the folding portions may be manufactured using rollers that compresses the main body at the fold lines. A perforating knife may also be used to perforate the fold lines. A scoring die may also be used to score the fold lines. It should also be understood that any other suitable type of manufacturing process may be employed to manually or automatically form the fold lines and associated folding portions, as desired.

Additionally, the fold lines may be formed by a combination of creasing and scoring. However, any other combination of compression, perforation, or scoring may be used within the scope of the disclosure.

In further embodiments, the packaging system may be a self-sealing box having a plurality of panels. For example, the self-sealing box may have a front panel, a bottom panel, a rear panel, a first top panel, a second top panel, and a front tab having the tamper evident structure and an adhesive portion. In a further non-limiting example, the adhesive portion may be an adhesive strip with a protective peelable liner that militates against the adhesive strips from inadvertently adhering to an undesirable object.

These various panels may be arranged adjacent to each other in an end-to-end relationship. The bottom panel may be laterally attached to a pair of lower side panels, and the first top panel may be laterally attached to the rear panel and the front tab. The second top panel may be laterally attached to the front panel. Upon folding, these panels form the front, bottom, rear, top and sides of the packaging system. However, it should be appreciated that any configuration or orientation of panels, fold lines and folding portions may be used for the main body, as desired.

In certain embodiments, the container may have side panels that are adhered to the front and rear panels by adhesive. For example, the adhesive may be double sided adhesive tape, glue, or a spray on adhesive; however, any adhesive may be chosen by a skilled artisan. In a further example, the side panels adhered to the front and rear panels facilitate a snapping of the front panel and the rear panel upward relative the bottom panel, where each side panel is moved outward relative to the opposing side panel. In a most particular embodiment, a corner of each side panel may be adhered to the front panel and the rear panel. As the side panels are moved outward, the corner will fold in half and the front panel and rear panel will become transverse to the bottom panel, thereby “snapping” the box blank into the container.

In operation, the container may be assembled by folding the side panels of the box blank outward relative to the bottom panel. The side panels may be adhered to the front panel and the rear panel, which facilitates an upward movement of the front panel, and the rear panel. The second top panel is then folded inwardly relative to the first top panel. A protrusion on a distal edge of the second top panel is received in a space between the side panels and the rear panel. The first top panel is then folded on top of the second top panel, and the protrusions of the first top panel are received in elongate apertures formed in each side panel. The front tab having the adhesive portion may be folded onto the front panel and adhered to the front panel. For example, where the adhesive portion is an adhesive strip having a peelable liner, the peelable strip is removed and the adhesive strip is pressed to the front panel.

In operation, once the package arrives at the desired destination, the tamper evident structure may be removed, and the container opened.

Furthermore, it should be appreciated that first top panel adhered to the front panel, militates against tampering with the package configuration and the tamper evident structure acts as an indicator by showing whether a third party tampered with the package configuration.

In a non-limiting example, the tamper evident structure may be a tear strip that extends across an outer surface of the front tab. For example, the tear strip is generally formed by two pairs of spaced apart and parallel cut lines of limited depth in the box-blank material. The cut lines may or may not extend completely through the blank material. Additionally, at one end of the tear strip may be a gripping portion to facilitate a gripping of the tear strip. However, it should be appreciated that any tamper evident structure may be chosen by one skilled in the art as desired.

In certain embodiments, the packaging system may be manufactured by cutting or stamping corrugated cardboard into a desired shape, thereby forming the main body. The main body may then be creased along predetermined fold lines, and optionally scored, perforated, or compressed, to facilitate the folding of the main body into the container. After the main body has been manufactured, the product display or advertising may be printed on a single side of the main body, or a label depicting the product may be adhered to one side of the box blank.

In an additional embodiment, the locking tab may be disposed off-center of the main body, and the folding portions have a curved outer edge.

In operation, the user may fold the panels of the main body into the container. Once the box is folded in the container, the user may secure the product within the main body. After the product is secured within the main body, the front tab may be adhered to the front panel of the box. Additionally, it should be appreciated that where the product is secured in the tamper-resistant package, the product display may be disposed on an exterior and interior surface of the container, where assembled.

In a further embodiment, for example, the side panels may not be adhered to the front and rear panels. According to this embodiment, each of the side panels may have a male locking component. The bottom panel may have a corresponding female locking component formed therethrough adjacent to each of the side panels.

Each of the side panels may have a folding portion such that the side panel may be configured to fold over itself at the fold lines. The side panel may fold inwardly relative to the bottom panel such that the male locking component of each of the side panels may be disposed in each of the female locking components of the bottom panel.

Each of the front panel and the rear panel may have a folding portion. The folding portion may be disposed on each of the lateral edges of the panels. The front and rear panels may fold inwardly toward the bottom panel. The folding portions may then fold inwardly toward the front and rear panels. Each of the side panels may then fold over the folding portion of the front and rear panels. The male locking component may be inserted into the female locking component thereby securing the box without the use of adhesive.

Advantageously, the foldable packaging system has a product display and militates against a third-party tampering with the package.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is a top plan view of a mailer with an outer lid in an opened position, an inner lid in a closed position, and further showing a first outer lid wing panel and a second outer lid wing panel in a folded position;

FIG. 2 is a first side elevational view of the mailer shown in FIG. 1, and further showing the outer lid having an adhesive panel;

FIG. 3 is a second side elevational view of the mailer shown in FIG. 1;

FIG. 4 is a front elevational view of the mailer shown in FIG. 1, and further showing the adhesive panel with a primary adhesive, a secondary adhesive, and a tear strip;

FIG. 5 is a rear elevational view of the mailer shown in FIG. 1;

FIG. 6 is a bottom plan view of the mailer shown in FIG. 1, with the outer lid in a closed position, and further showing the first aperture, the second aperture, the third aperture, and the fourth aperture;

FIG. 7 is a top perspective view of the mailer shown in FIG. 1, and further showing the outer lid in a closed position;

FIG. 8 is a top perspective view of the mailer shown in FIG. 1, and further showing the outer lid in the opened position and the inner lid in the closed position;

FIG. 9 is a top perspective view of the mailer shown in FIG. 1, and further showing the outer lid in the opened position and the inner lid in the opened position;

FIG. 10 is top plan view of a folding blank for constructing the mailer, according to one embodiment;

FIG. 11 is a bottom plan view of the folding blank shown in FIG. 10;

FIG. 12 is a top plan view of the folding blank shown in FIG. 10, and further showing the first outer lid wing panel and the second outer lid wing panel in the folded position;

FIG. 13 is a top plan view of a folding blank for constructing the mailer, and further showing the inner lid having a free end panel, according to another embodiment of the disclosure;

FIG. 14 is enlarged top plan view of the folding blank taken at call-out A in FIG. 12, and further showing a first transitional panel;

FIG. 15 is a cross sectional view of the folding blank taken at section line B-B in FIG. 12, and further showing the first outer lid wing panel and the second outer lid wing panel with an adhesive, the primary adhesive with a peel-away film, the secondary adhesive with the peel-away film, and the tear strip with a tear strip film;

FIG. 16 is an enlarged top plan view of the folding blank taken at call-out D in FIG. 12, and further showing the primary adhesive, the tear strip, and the secondary adhesive;

FIG. 17 is an enlarged top plan view of the folding blank taken at call-out C in FIG. 12, and further showing a chamfer edge;

FIG. 18 is a top perspective view of the folding blank shown in FIG. 10 in the process of being constructed into the mailer; and

FIG. 19 is a flowchart showing a method for constructing the mailer, according to one embodiment of the disclosure.

### DETAILED DESCRIPTION

The following detailed description and appended drawings describe and illustrate various embodiments of the invention. The description and drawings serve to enable one skilled in the art to make and use the invention and are not intended to limit the scope of the invention in any manner. In respect of the methods disclosed, the order of the steps presented is exemplary in nature, and thus, is not necessary or critical unless otherwise disclosed.

As used herein, the term “folding blank” refers to box blanks, most desirably made of paper or corrugated cardboard. The box blanks are folded to form folded boxes.

As used herein, the term “mailer” refers to a folding blank folded into a box having a lid. However, it should be appreciated that other types of boxes are contemplated and may therefore be included within the scope of this disclosure.

As used herein, the term “folding line” refers to a line or mark made by folding or doubling a pliable substance. However, it should be appreciated that a skilled artisan may employ a mechanical bearing, such as a hinge, to substitute the folding operation, as desired.

As used herein, the term “panel” may refer to sections of the main body or may include separate pieces affixed to the main body.

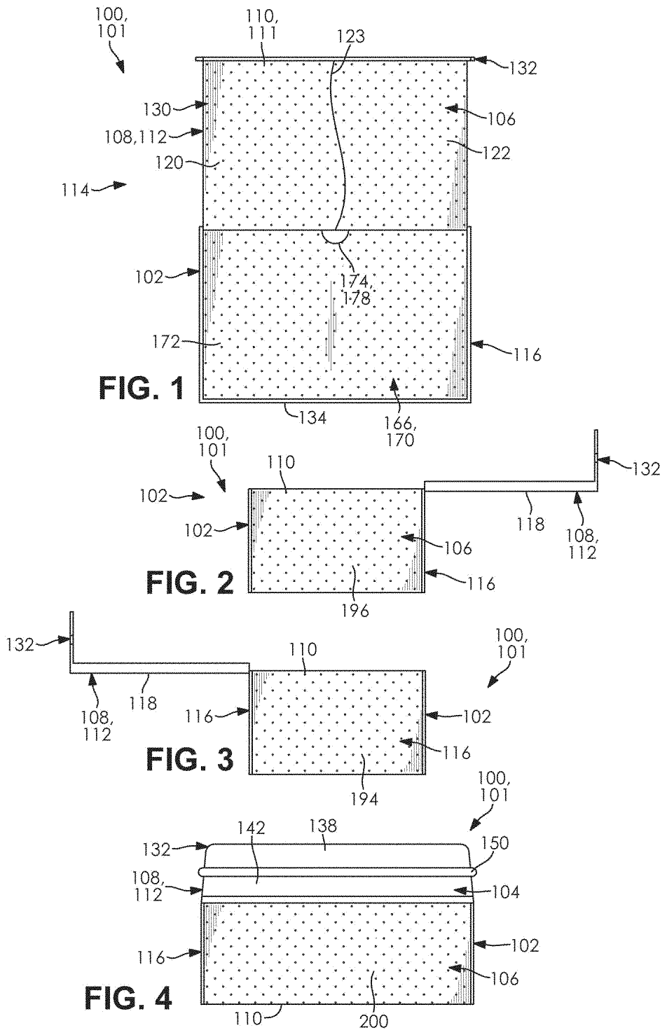

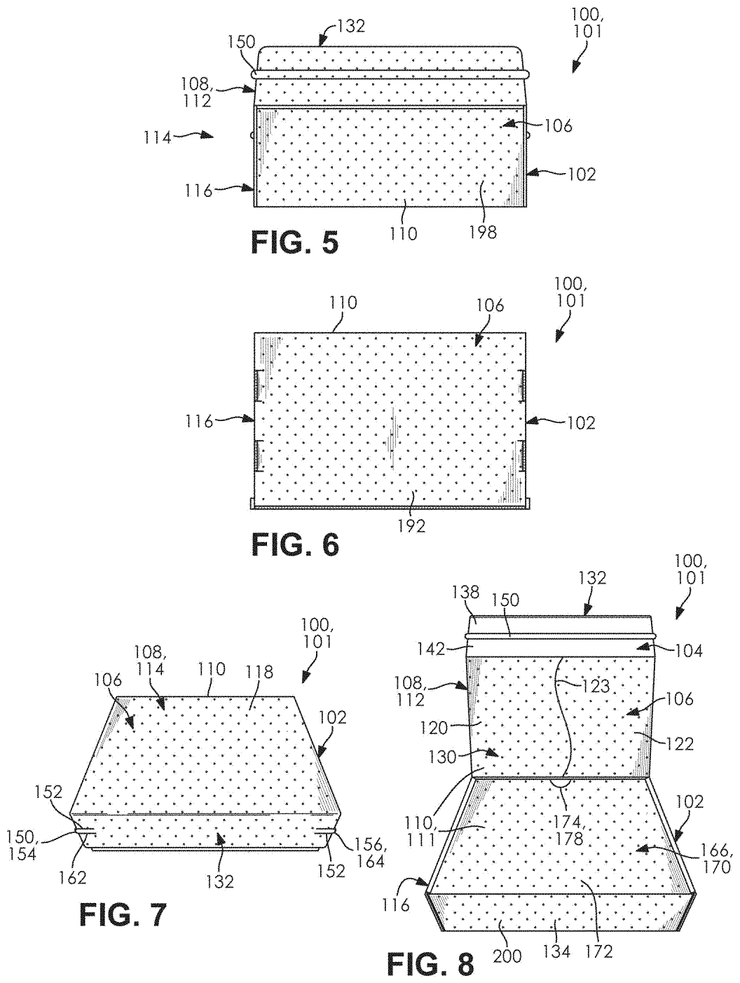

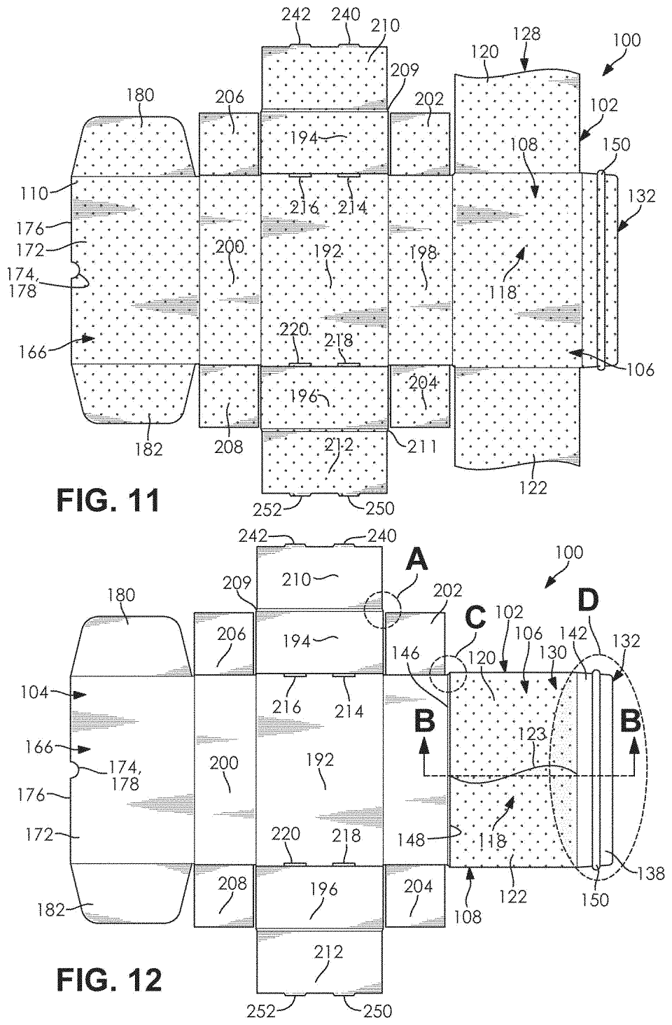

As shown in FIGS. 1-18, a folding blank 100 for constructing a mailer 101 has a main body 102. The main body 102 is configured to be folded into the mailer 101, shown in FIGS. 1-9. The main body 102 has an inner surface 104, an outer surface 106, and outer lid 108. In some examples, the main body 102 may be manufactured from paper or corrugated cardboard. It should be appreciated that a skilled artisan may manufacture the main body 102 from other suitable materials that are capable of being folded.

In particular embodiments, the main body 102 may have a total length of about twenty-nine inches (29.062″) and a total width of about twenty-one inches (21.687″). Although these dimensions have been shown to be useful, other dimensions may be employed by a person skilled in the art, as desired.

The inner surface 104 has no printing 110 thereon, while still allowing for printing 110 to be seen on the inside of the mailer 101, where assembled, and as shown in FIGS. 1 and 8-9. Desirably, eliminating the step of printing 110 on the inner surface 104, may conserve time and resources in the manufacturing process. In addition, it is believed saving resources from less printing 110 overall will result in an eco-friendlier mailer 101.

As shown in the drawings as a dotted shading pattern in FIGS. 1-9, 11-12, and 16-18, the outer surface 106 may have printing 110 disposed thereon. Nonlimiting examples of printing 110 includes advertisements consisting of words and drawings. It should be appreciated that one skilled in the art may employ different printing 110, as desired.

Referring now to FIGS. 1, 8-9, and 18, where the folding blank 100 is folded into the mailer 101, portions 111 of the printing 110 can still be visible on the inside of the mailer 101. Advantageously, this allows for printing 110 to be only disposed on the outer surface 106, while still allowing it to be seen from the inside of the mailer 101.

The outer lid 108 is configured to selectively move between an opened position 112 and a closed position 114, where a remainder of the folding blank 100 has been folded into a box 116. The opened position 112 allows for contents (not shown) to be accessed. In addition, the opened position 112 allows for the portions 111 of printing 110 to be seen, shown in FIGS. 1, 8-9, and 18. Desirably, this permits a user to see the printing 110, which may be directed advertisements, where the outer lid 108 is in the opened position 112. It should be appreciated that a skilled artisan may employ additional positions for the outer lid 108, within the scope of this disclosure.

With reference to FIGS. 1, 8-13, and 18, the outer lid 108 may have an outer lid panel 118, a first outer lid wing panel 120, and a second outer lid wing panel 122. The outer lid panel 118 may be laterally connected to the first outer lid wing panel 120 and the second outer lid wing panel 122.

In particular embodiments, the outer lid panel 118 has a length of about six inches (6.187″) and a width of about nine inches (9.375″). Each of the first outer lid wing panel 120 and the second outer lid wing panel 122 have a length less than the length of the outer lid panel 118. In addition, each of the first outer lid wing panel 120 and the second outer lid wing panel 122 have a width of about four inches (4.687″). Although these dimensions have shown to be useful, one skilled in the art my select different dimesons as desired.

Now referring to FIG. 12, a first folding line 124 is formed between the outer lid panel 118 and the first outer lid wing panel 120. The first outer lid wing panel 120 is configured to be moveable along the first folding line 124.

A second folding line 126 is formed between the outer lid panel 118 and the second outer lid wing panel 122. The first folding line 124 is oriented parallel to the second folding line 126. The second outer lid wing panel 122 is configured to be moveable along the second folding line 126.

In particular examples, each of the first outer lid wing panel 120 and the second outer lid wing panel 122 are configured to fold inwardly from an unfolded position 128 to a folded position 130.

As shown in FIGS. 10-11, and 13, where the first outer lid wing panel 120 and the second outer lid wing panel 122 are in the unfolded position 128, both the inner surface 104 of the first outer lid wing panel 120 and the second outer lid wing panel 122 are not adjacent to and not facing the inner surface 104 of the outer lid panel 118.

With reference to FIGS. 1, 8-9, 12, and 18, where the first outer lid wing panel 120 and the second outer lid wing panel 122 are in the folded position 130, both the inner surface 104 of the first outer lid wing panel 120 and the second outer lid wing panel 122 are adjacent to and facing the inner surface 104 of the outer lid panel 118. Advantageously, the folded position 130 permits the user to view the outside surface 106, which has printing 110 thereon, of both the first outer lid wing panel 120 and the second outer lid wing panel 122 while the outer lid is in the opened position 112. It should be appreciated that the main body 102 of the folding blank 100 may include additional panels (not shown) that can fold inwardly into the folded position 130 to permit more printing 110 to be shown while the outer lid is in the opened position 112.

In some examples, each of the first outer lid wing panel 120 and the second outer lid wing panel 122 has an outer edge 123, as shown in FIGS. 1, 8-9, 12, and 18. The outer edge 123 of the first outer lid wing panel 120 corresponds to and abuts the outer edge 123 of the second outer lid wing panel 122 where the first outer lid wing panel 120 and the second outer lid wing panel 122 are in the folded position 130.

While still referring to FIGS. 1, 8-9, 12, and 18, the outer edge 123 of each of the first outer lid wing panel 120 and the second outer lid wing panel 122 may be serpentine. Without being bound to a particular belief, it is believed having the outer edge 123 be serpentine permits a user to more easily interlock the first outer lid wing panel 120 with the second outer lid wing panel 122. It should be appreciated that a person skilled in the art my employ other shapes for the outer edge 123, as desired.

In addition, each of the first outer lid wing panel 120 and the second outer lid wing panel 122 may also include a chamfer edge 144, shown particularly in FIG. 17. The chamfer edge 144 of the first outer lid wing panel 120 is formed on a bottom portion 146 of the first outer lid wing panel 120 opposite to the outer edge 123 of the first outer wing panel 120. The chamfer edge 144 of the second outer lid wing panel 122 is formed on a bottom portion 148 of the second outer lid wing panel 122 opposite to the outer edge 123 of the second outer wing panel 122. It should be appreciated that the chamfer edge 144 permits for an easier folding of the first outer lid wing panel 120 and the second outer lid wing panel 122.

In some instances, the inner surface 104 of the first outer lid wing panel 120 and the inner surface 104 of the second outer lid wing panel 122 are selectively affixed to the outer lid. In other instances, the inner surface 104 of the first outer lid wing panel 120 and the inner surface 104 of the second outer lid wing panel 122 are affixed to the outer lid via an adhesive 125. Non-limiting examples of the adhesive 125 include pressure sensitive adhesives, such as various tapes, or polyvinyl acetate. It should be appreciated that one skilled in the art may employ other types of adhesives as the adhesive 125, within the scope of this disclosure.

Now referencing FIGS. 4-5, 7-13, 16, and 18, the outer lid 108 further includes an adhesive panel 132. The adhesive panel 132 is configured to secure the outer lid 108 to a portion of the box 134 where the box 116 is assembled. In some examples, the adhesive panel 132 may be laterally connected to the outer lid 108.

A third folding line 136 may be formed between the adhesive panel 132 and the outer lid panel 118, shown in FIG. 10. The third folding line 136 is orthogonal to the first folding line 124 and the second folding line 126.

The adhesive panel 132 is further configured to move along the third folding line 136. In particular examples, the adhesive panel 132 is configured to fold inwardly to secure the outer lid 108 to the portion of the box 134 where the box 116 is assembled, as shown in FIG. 7.

In even more specific examples, the adhesive panel 132 has a length of about one inch (1.75″) and a width of about nine inches (9.375″). Although these dimensions have shown to be useful, it should be appreciated that a skilled artisan may select different dimensions for the adhesive panel 132, within the scope of this disclosure.

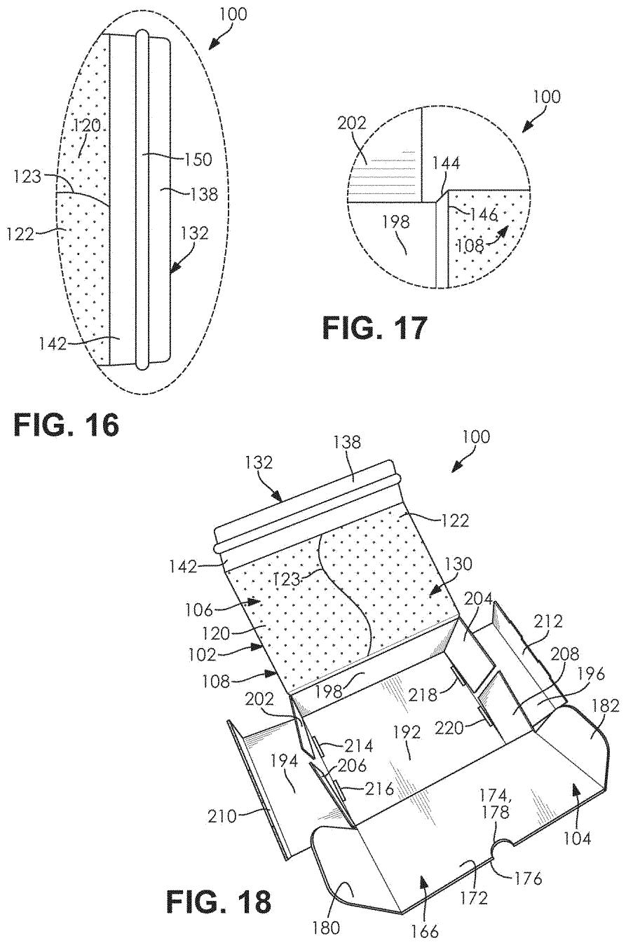

As shown particularly in FIG. 16, the inner surface 104 of the adhesive panel 132 may include a primary adhesive 138. The primary adhesive 138 is configured to affix the outer lid 108 to the portion of the box 134 where the outer lid is in the closed position 114. Non-limiting examples of the primary adhesive 138 include pressure sensitive adhesives, such as various tapes, or polyvinyl acetate. It should be appreciated that a person skilled in the art may employ other types of adhesives as the primary adhesive 138, as desired.

While still referring to FIG. 16, the adhesive panel 132 may further include a secondary adhesive 142. The secondary adhesive 142 is configured to reseal the outer lid 108 to the portion of the box 134 to the outer lid 108 where the user wants to reseal the mailer 101 for further shipments. It should be appreciated that the adhesive panel 132 may further include additional adhesives (not shown) to allow the mailer 101 to be resealed numerous times.

In specific examples, each of the primary adhesive 138 and the secondary adhesive 142 includes a peel-away film 140 disposed thereon, shown in FIG. 15. The peel-away film 140 of the primary adhesive 138 is configured to be removed to expose the primary adhesive 138 to affix the outer lid 108 to the portion of the box 134 where the outer lid 108 is in the closed position 114 and needs to be sealed. The peel-away film 140 of the secondary adhesive 142 is configured to be removed to expose the secondary adhesive 142 to affix the outer lid 108 where the outer lid 108 is in the closed position 114 and needs to be resealed.

A non-limiting example of the peel-away film 140 include a polypropylene-based film. Although, it should be appreciated that a skilled artisan may employ other types of films to be used for the peel-away 140, within the scope of this disclosure.

Referring back to FIG. 16, the adhesive panel 132 may further include a tear strip 150. The tear strip 150 is configured to be torn from the adhesive panel 132 to remove the primary adhesive 138 from the adhesive panel 132. The tear strip 150 is disposed between the primary adhesive 138 and the secondary adhesive 142.

In particular examples, the primary adhesive 138 is disposed below the tear strip 150 and the secondary adhesive 142. This configuration allows the tear strip 150 to function as a tamper proof seal because the tear strip 150 may be torn to remove the primary adhesive 138 from the adhesive panel 132 to thereby allow the outer lid to be moved to then opened position 112. Advantageously, this allows the user to easily observe where the outer lid has been moved to the opened position 112 by checking if the tear strip 150 is still a part of the adhesive panel 132.

The tear strip 150 may be a perforated tear strip 150 formed on the adhesive panel 132 by a pair of parallel perforated lines 152 that have been spaced apart and cut with limited depth on the adhesive panel 132, shown in FIG. 7. It should be appreciated that a skilled artisan may or may not have the pair of parallel perforated lines 152 extend completely through the adhesive panel 132, as desired.

In some instances, the pair of parallel perforated lines 152 are disposed along the entirety of the tear strip 150. This permits the tear strip 150 to be easily removed along the pair of parallel perforated lines 152 while also militating against excess portions of the adhesive panel 132 from being torn off during the process.

In other instances, the tear strip 150 includes a tear strip film 158, shown in FIG. 15. In addition, the pair of parallel perforated lines 152 are only disposed at one end 154 and at an opposite end 156 of the tear strip 150. The tear strip film 158 is affixed along the tear strip 150 with a tear adhesive 160. The tear strip film 158 is configured to pull the non-perforated parts of the tear strip 150 to aid in removing the entirety of the tear strip 150 where the user removes the tear strip 150.

Non-limiting examples of tear strip 150 include a polypropylene-based film. Although, it should be appreciated that a skilled artisan may employ other types of films to be used for the tear strip 150, within the scope of this disclosure.

Non-limiting examples of the tear adhesive 160 include pressure sensitive adhesives, such as various tapes, or polyvinyl acetate. It should be appreciated that a person skilled in the art may employ other types of adhesives as the tear adhesive 160, as desired.

As shown in FIG. 7, the tear strip 150 may include a first gripping tab 162 at one end 154 and a second gripping tab 164 at the opposite end 156 of the tear strip 150. Each of the first gripping tab 162 and the second gripping tab 164 extend outwardly from the adhesive panel 132. In addition, each of the first gripping tab 162 and the second gripping tab 164 are configured to facilitate a better gripping of the tear strip 150 where the user removes the tear strip 150 from the adhesive panel 132. It should be appreciated that one skilled in the art may select different kinds of tear strips for the tear strip 150.

With reference to FIGS. 1, 8-13, and 18, the main body 102 of the folding blank 100 may further includes an inner lid 166. The inner lid 166 is disposed opposite to the outer lid 108. The inner lid 166 is configured to move between an inner opened position 168 and an inner closed position 170 where the box 116 is assembled. The outer surface 106 of the inner lid 166 is visible where the inner lid 166 is in the inner closed position 170 and the outer lid 108 is in the opened position 112, as shown in FIGS. 1 and 8. Desirably, this allows the user to view printing 110 on the outer surface 106 of the inner lid 166 where the inner lid 166 is in the inner closed position 170 and the outer lid 108 is in the opened position 112.

In some embodiments, the inner lid 166 includes an inner lid panel 172 with a finger aperture 174 thereon. The finger aperture 174 a gripping of the inner lid 166 to move the inner lid 166 from the inner closed position 170 to the inner opened position 168.

In particular examples, the inner lid 166 includes a free edge 176 and a central portion 178 of the free edge 176 defines the finger aperture 174, shown in FIGS. 1, 8-12, and 18. It should be appreciated that other shapes may be employed for the finger aperture 174, within the scope of this disclosure.

In specific examples, the finger aperture 174 has a radius of about three eighths of an inch (0.375″). Although this dimension has been shown to be useful, other dimensions for the finger aperture 174 may be employed by a skilled artisan, as desired.

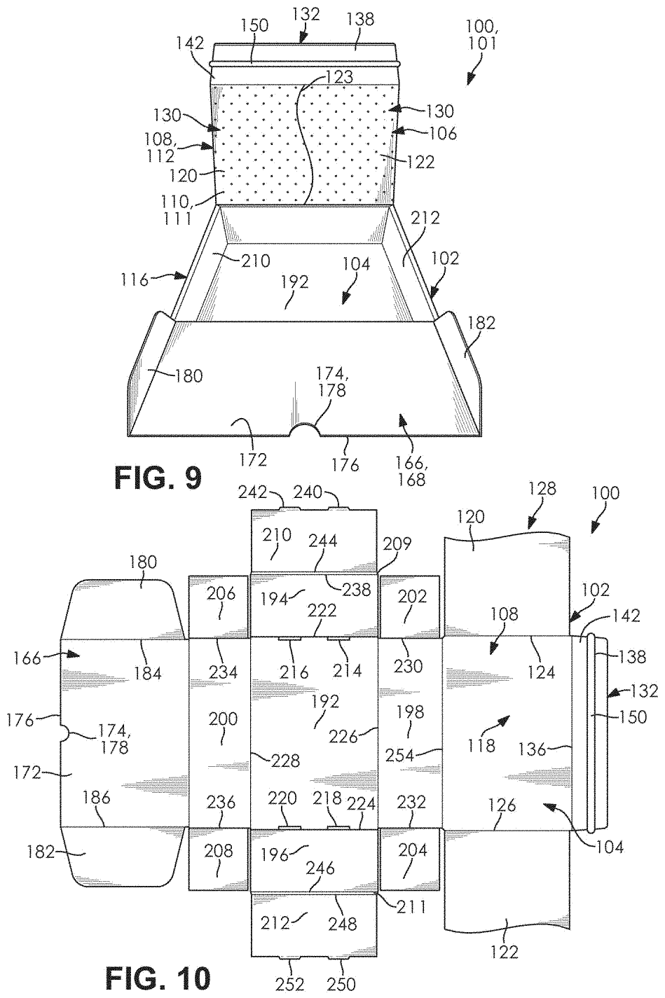

Now referencing FIGS. 9-12, and 18, the inner lid 166 may also have a first inner lid wing panel 180 and a second inner lid wing panel 182. The inner lid panel 172 is laterally connected to the first inner lid wing panel 180 and the second inner lid wing panel 182.

In specific examples, the inner lid panel 172 has a length of about six inches (6″). Each of the first inner lid wing panel 180 and the second inner lid wing panel 182 has a width of about three inches (3″) and a length of about less than six inches (6″). Although these dimensions have been shown to be useful, other dimensions may be selected by one skilled in the art, within the scope of this disclosure.

As shown in FIG. 10, a fourth folding line 184 is formed between the first inner lid wing panel 180 and the inner lid panel 172. The first inner lid wing panel 180 is configured to move along the fourth folding line 184.

A fifth folding line 186 is formed between the second inner lid wing panel 182 and the inner lid panel 172, shown in FIG. 10. The fifth folding line 186 is oriented parallel to the fourth folding line 184. The second inner lid wing panel 182 is configured to move along the fifth folding line 186.

More specifically, each of the first inner lid wing panel 180 and the second inner lid wing panel 182 are configured to be folded inwardly along the fourth folding line 184 and the fifth folding line 186, respectively. Each of the first inner lid wing panel 180 and the second inner lid wing panel 182 are not visible where the inner lid 166 is in the inner closed position 170, as shown in FIGS. 1 and 8. Now referencing FIGS. 9-12 and 18, each of the first inner lid wing panel 180 and the second inner lid wing panel 182 are configured to be visible where the inner lid 166 is in the inner opened position 168.

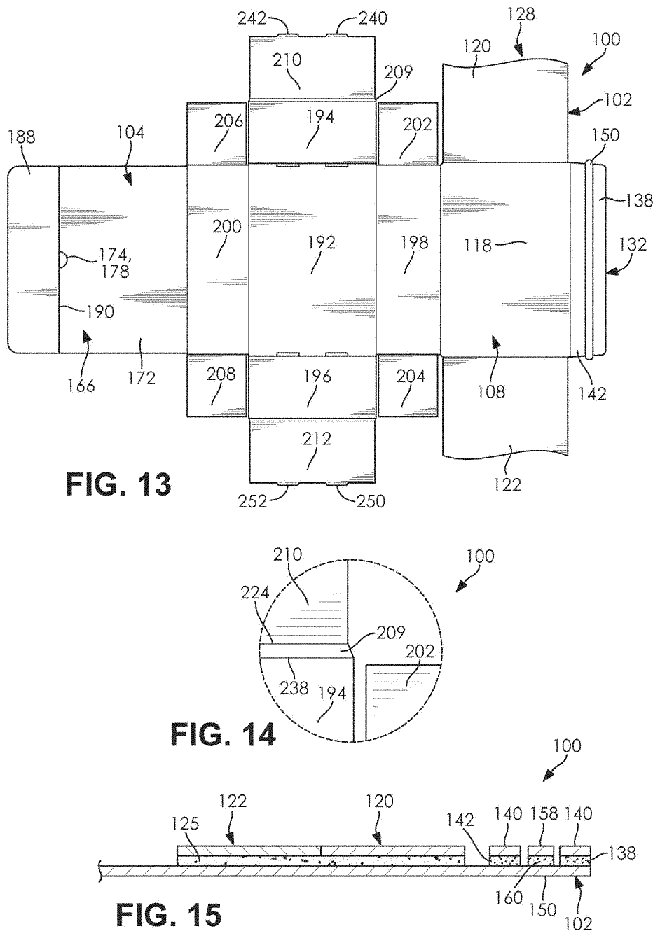

With reference to FIG. 13, the inner lid 166 has a free end panel 188. The free end panel 188 is laterally connected to the inner lid panel 172 with the finger aperture 174 disposed between the inner lid panel 172 and the free end panel 188.

A sixth folding line 190 is formed between the inner lid 166 and the free end panel 188, as shown in FIG. 10. The sixth folding 190 is oriented parallel to the third folding line 136 and oriented orthogonal to the fourth folding 184 and the fifth folding 186. The free end panel 188 is configured to move along the sixth folding line 190.

In particular, the free end panel 188 is configured to fold inwardly along the sixth folding line 190 where the inner lid 166 is in the inner closed position 170. The free panel 188 is not visible where the inner lid 166 is in the inner closed position 170. Also, the free end panel 188 is further configured to be visible where the inner lid 166 is in the inner opened position 168.

As shown in FIGS. 10-13, the folding blank 100 may further include a base panel 192, a first supporting latch panel 194, a second supporting latch panel 196, a supporting outer lid panel 198, a supporting inner lid panel 200, a first supporting outer lid wing panel 202, a second supporting outer lid wing panel 204, a first supporting inner lid wing panel 206, a second supporting inner lid wing panel 208, a first transitional panel 209, a first latch panel 210, a second transitional panel 211, and a second latch panel 212.

While still referring to FIGS. 10-13, the base panel 192 is laterally connected to the first supporting latch panel 194, the second supporting latch panel 196, the supporting outer lid panel 198, and the supporting inner lid panel 200. The base panel 192 includes a first aperture 214, a second aperture 216, a third aperture 218, and a fourth aperture 220. The first aperture 214 and the second aperture 216 is disposed adjacent to the first supporting latch panel 194. The third aperture 218 and the fourth aperture 220 are disposed opposite to the first aperture 214 and the second aperture 216 and adjacent to the second supporting latch panel 196.

In particular examples, the base panel 192 has a length of about six inches (6.062″) and a width of about nine inches (9.375″). Although these dimensions have shown to be useful, a person skilled in the art may select different dimensions for the base panel 192.

Now referencing FIG. 10, a seventh folding line 222 is formed between the first supporting latch panel 194 and the base panel 192. The first supporting latch panel 194 is configured to move along the seventh folding line 222. Where the box 116 is assembled, the first supporting outer lid wing panel 194 is positioned upwardly from the base panel 192 via the seventh folding line 222, such that a 90-degree angle is formed between the first supporting latch panel 194 and the base panel 192.

An eighth folding line 224 is formed between the second supporting latch panel 196 and the base panel 192, shown in FIG. 10. The eighth folding line 224 is oriented parallel to the seventh folding line 222. The second supporting latch panel 196 is configured to move along the eighth folding line 224. Where the box 116 is assembled, the second supporting latch panel 196 is positioned upwardly from the base panel 192 via the eighth folding line 224, such that a 90-degree angle is formed between the second supporting latch 196.

In specific examples, each of the first supporting latch panel 194 and the second supporting latch panel 196 have a length of about six inches (6.062″) and a width of about three inches (3″). It should be appreciated that one skilled in the art may select different dimensions for the first supporting latch panel 194 and the second supporting latch panel 196, as desired.

Referring back to FIG. 10, a ninth folding line 226 is formed between the supporting outer lid panel 198 and the base panel 192. The ninth folding line 226 is oriented orthogonal to the seventh folding 222 and the eighth folding line 224. The supporting outer lid panel 198 is configured to move along the ninth folding line 226. Where the box 116 is assembled, the supporting outer lid panel 198 is positioned upwardly from the base panel 192 via the ninth folding line 226, such that a 90-degree angle is formed between the supporting outer lid panel 198 and the base panel 192.

A tenth folding line 228 is formed between the supporting inner lid panel 200 and the base panel 192, shown in FIG. 10. The tenth folding line 228 is oriented parallel to the ninth folding line 226. The supporting inner lid panel 200 is configured to move along the tenth folding line 228. Where the box 116 is assembled, the supporting inner lid panel 200 is positioned upwardly from the base panel 192 via the tenth folding line 228, thereby creating a 90-degree angle between the supporting inner lid panel 200 and the base panel 192.

As a non-limiting example, the supporting outer lid panel 198 and the supporting inner lid panel 200 may have a length of about 3 inches (3.125″). Although it should be appreciated that a skilled artisan may utilize other dimensions for the supporting outer lid panel 198 and the supporting inner lid panel 200.

As shown in FIGS. 10-13, the first supporting outer lid wing panel 202, the second supporting outer lid wing panel 204, and the outer lid panel 118 are laterally connected to the supporting outer lid panel 198.

An eleventh folding line 230 is formed between the first supporting outer lid wing panel 202 and the supporting outer lid panel 198, shown in FIG. 10. The eleventh folding line 230 is oriented orthogonal to the ninth folding line 226. The first supporting outer lid wing panel 202 is configured to move along the eleventh folding line 230. Where the box 116 is assembled, the first supporting outer lid wing panel 202 is folded inwardly towards the base panel 192, such that a 90-degree angle is formed between the first supporting outer lid wing panel 202 and the supporting outer lid panel 198, as shown in FIG. 18. The outer surface 106 of the first supporting outer lid wing panel 202 abuts and faces the inner surface 104 of the supporting outer lid panel 198.

Now referring back to FIG. 10, a twelfth folding line 232 is formed between the second supporting outer lid wing panel 204 and the supporting outer lid panel 198. The twelfth folding line 232 is oriented parallel to the eleventh folding line 230. The second supporting outer lid wing panel 204 is configured to move along the twelfth folding line 232. Where the box 116 is assembled, the second supporting outer lid wing panel 204 is folded inwardly towards the base panel 192, thereby creating a 90-degree angle between the second supporting outer lid wing panel 204 and the supporting outer lid panel 198, shown in FIG. 18. The outer surface 106 of the second supporting outer lid wing panel 204 abuts and faces the inner surface 104 of the supporting outer lid panel 198.

A nineteenth folding line 254 is formed between the supporting outer lid panel 198 and the outer lid panel 118, as shown in FIG. 10. The nineteenth folding line 254 is oriented parallel to the ninth folding line 226. The outer lid panel 118 is configured to move along the nineteenth folding line 254. Where the box 116 is assembled, the outer lid panel 118 is configured to move between the opened position 112 and the closed position 114. In the opened position 112, the inner surface 104 of the outer lid panel 118 does not face the inner surface 104 of the base panel 192. In the closed position 114, the inner surface 104 of the outer lid panel 118 faces the inner surface 104 of the base panel 192.

The first supporting inner lid wing panel 206 and the second supporting inner lid wing panel 208 are laterally connected to the supporting inner lid panel 200.

While still referring to FIG. 10, a thirteenth folding line 234 is formed between the first supporting inner lid wing panel 206 and the supporting inner lid panel 200. The thirteenth folding line 234 is oriented orthogonal to the tenth folding line 228. The first supporting inner lid wing panel 206 is configured to move along the thirteenth folding line 234. Where the box 116 is assembled, the first supporting inner lid wing panel 206 is folded inwardly towards the base panel 192, such that a 90-degree angle is formed between the first supporting inner lid wing panel 206 and the supporting inner lid panel 200. The outer surface 106 of the first supporting inner lid wing panel 206 abuts and faces the inner surface 104 of the supporting inner lid panel 200.

A fourteenth folding line 236 is formed between the second supporting inner lid wing panel 208 and the supporting inner lid panel 200. The fourteenth folding line 236 is oriented parallel to the thirteenth folding line 234. The second supporting inner lid wing panel 208 is configured to move along the fourteenth folding line 236. Where the box 116 is assembled, the second supporting inner lid wing panel 208 is folded inwardly towards the base panel 192, such that a 90-degree angle is formed between the second supporting inner wing panel 208 and the supporting inner lid panel 200. The outer surface 106 of the second supporting inner lid wing panel 208 abuts and faces the inner surface 104 of the supporting inner lid panel 200.

In particular examples, each of the first supporting outer lid wing panel 202, the second supporting outer lid wing panel 204, the first supporting inner lid wing panel 206, and the second supporting inner lid wing panel 208 have a length of about two inches (2.937″) and a width of about three inches (3″). Although these dimensions have been shown to be useful, a skilled person may select other dimensions, within the scope of this disclosure.

As shown in FIGS. 10-13, the first transitional panel 209 is laterally connected to the first supporting latch panel 194. A fifteenth folding line 238 is formed between the first transitional panel 209 and the first supporting latch panel 194, shown particularly in FIG. 10. The fifteenth folding line 238 is oriented parallel to the seventh folding line 222. The first transitional panel 209 is configured to move along the fifteenth folding line 238. Where the box 116 is assembled, the first transitional panel 209 is folded inwardly towards the base panel 192, in such a way that the inner surface 104 of the first transitional panel 209 abuts and faces the first supporting outer lid wing panel 202 and the first supporting inner lid wing panel 206.

With reference to FIGS. 10-13, the first latch panel 210 is laterally connected to the first transitional panel 209. The first latch panel 210 has a first tab 240 and a second tab 242. The first tab 240 and the second tab 242 are configured to be disposed within the first aperture 214 and the second aperture 216 of the base panel 192, respectively.

A sixteenth folding line 244 is formed between the first latch panel 210 and the first transitional panel 209, as shown in FIG. 10. The sixteenth folding line 244 is oriented parallel to the fifteenth folding line 238. The first latch panel 210 is configured to be moveable along the sixteenth folding line 244. Where the box 116 is assembled, the first latch panel 210 is folded downwardly towards the base panel 192, wherein the inner surface 104 of the first latch panel 210 abuts and faces the inner surface 104 of the first supporting outer lid wing panel 202 and the first supporting inner lid wing panel 206. The first tab 240 is disposed inside the first aperture 214 of the base panel 192 and the second tab 242 is disposed inside the second aperture 216 of the base panel 192, thereby locking the first latch panel 210 into position.

Now referring to FIGS. 10-13, the second transitional panel 211 is laterally connected to the second supporting latch panel 198. A seventeenth folding line 246 is formed between the second transitional panel 211 and the second supporting latch panel 196, shown in FIG. 10. The seventeenth folding line 246 is oriented parallel to eight folding line 224. The second transitional panel 211 is configured to be move along the seventeenth folding line 246. Where the box 116 is assembled, the second transitional panel 211 is folded inwardly towards the base panel 192, in such a way that the inner surface 104 of the second transitional panel 211 abuts and faces the second supporting outer lid wing panel 204 and the second supporting inner lid wing panel 208.

The second latch panel 212 is laterally connected to the second transitional panel 211, as shown in FIG. 10. The second latch panel 212 has a third tab 250 and a fourth tab 252. The third tab 250 and the fourth tab 252 are configured to be disposed within the third aperture 218 and the fourth aperture 220 of the base panel 192, respectively.

While still referring to FIG. 10, an eighteenth folding line 248 is formed between the second latch panel 212 and the second transitional panel 211. The second latch panel 212 is configured to move along the eighteenth folding line 248. Where the box 116 is assembled, the second latch panel 212 is folded downwardly towards the base panel 192, wherein the inner surface 104 of the second latch panel 212 abuts and faces the inner surface 104 of the second supporting outer lid wing panel 204 and the second supporting inner lid wing panel 208. The third tab 250 is disposed inside the third aperture 218 and the fourth tab 252 is disposed inside the fourth aperture 220 of the base panel 192, thereby locking the second latch panel 212 into position.

In particular embodiments, each of the first transitional panel 209 and the second transitional panel 211 have a width of about one-eighth of an inch (0.125″). In addition, each of the first latch panel 210 and the second latch panel 212 have a length of about six inches (6.026″) and a width of about two inches (2.968″). Although these dimensions have been shown to useful, a skilled artisan may select other dimensions, as desired.

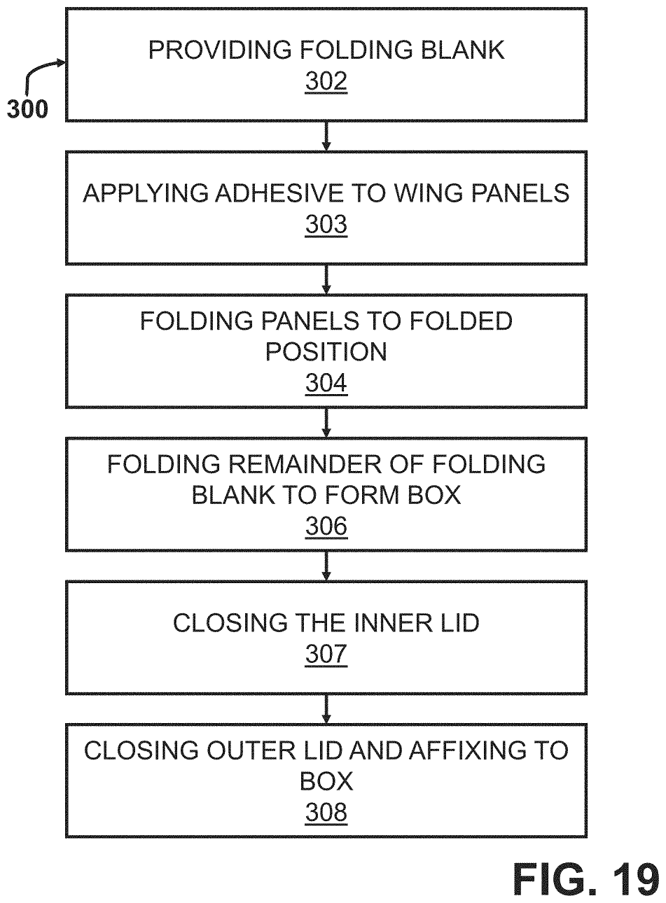

Referring now to FIG. 19, a method 300 for constructing the mailer 101 is shown. The method 300 includes a step 302 of providing the folding blank 100.

Next, the first outer lid wing panel 120 and the second outer lid wing panel 122 are folded inwardly from the unfolded position 128 to the folded position 130, in a step 304. The outer surface 106 of each of the first outer lid wing panel 120 and the outer surface 106 of the second outer lid wing panel 122 is visible where the outer lid 108 is in the opened position 112.

In a step 306, the remainder of the folding blank 100 is folded to form the box 116. As mentioned above, the outer surface 106 of each of the first outer lid wing panel 120 and the second outer lid wing panel 122 are visible where the outer lid 108 is in the opened position 112. Desirably, this permits the user to see the printing 110 where the outer lid 108 is in the opened position 112.

In some embodiments, the method 300 also includes a step 303 of applying the adhesive 125 to at least one of the inner surface 104 of the first outer lid wing panel 120, the inner surface 104 of the second outer lid wing panel 122, and the outer lid panel 118, prior to the step 304. Advantageously, the adhesive 125 secures the first outer lid wing panel 120 and the second outer lid wing panel 122 into position, so the outer surface 106 of the first outer lid wing panel 120 and the second outer lid wing panel 122 are visible where the outer lid 108 is in the opened position 112.

In a further embodiment, the method 300 may further includes a step 308 of moving the outer lid 108 to the closed position 114 so that the primary adhesive 138 abuts a portion of the box 134, thereby affixing the outer lid 108 to the portion of the box 134. Desirably, this secures the contents of the mailer 101.

In yet a further embodiment, the method 300 further includes a step 307 of moving the inner lid to the inner closed position 170, prior to the step 308. Advantageously, the outer surface 106 of the inner lid 166 provides another way for the user to see the printing 110.

Advantageously, the folding blank 100 and method 300 can display printing 110, such as advertisements on the inside of mailer 101, when assembled, via the first outer lid wing panel 120 and the second outer lid wing panel 122. The mailer 101, when assembled, can be easily secured using the primary adhesive 138. Likewise, the mailer 101 can be easily opened by removing the tear strip 150. Also, the mailer 101 may militate against tampering by the user observing if the tear strip 150 has been removed from the mailer 101. In addition, the mailer 101 can be resealed by using the secondary adhesive 142.

While certain representative embodiments and details have been shown for purposes of illustrating the invention, it will be apparent to those skilled in the art that various changes may be made without departing from the scope of the disclosure, which is further described in the following appended claims.

What is claimed is:

1. A folding blank for constructing a mailer, comprising:
a main body having an inner surface and an outer surface, the inner surface having no printing thereon, and the outer surface having printing thereon, the main body further including an outer lid configured to selectively move between an opened position and a closed position where a remainder of the folding blank has been folded into a box, the outer lid having an outer lid panel, a first outer lid wing panel, and a second outer lid wing panel, each of the first outer lid wing panel and the second outer lid wing panel configured to fold inwardly from an unfolded position to a folded position so that the inner surface of the first outer lid wing panel and the inner surface of the second outer lid wing panel are disposed adjacent to and facing the inner surface of the outer lid panel in the folded position,
wherein the outer surface of each of the first outer lid wing panel and the outer surface of the second outer lid wing panel is visible where the outer lid is in the opened position.

2. The folding blank of claim 1, wherein the outer lid further includes an adhesive panel, the inner surface of the adhesive panel having a primary adhesive configured to affix the outer lid to a portion of the box where the outer lid is in the closed position.

3. The folding blank of claim 2, wherein the primary adhesive has a peel-away film disposed thereon, the peel-away film configured to be removed to expose the primary adhesive to affix the outer lid to the portion of the box.

4. The folding blank of claim 3, wherein the adhesive panel has a secondary adhesive with a peel-away film disposed thereon, the peel-away film of the secondary adhesive configured to be removed to expose the secondary adhesive to reseal the outer lid to the portion of the box.

5. The folding blank of claim 4, wherein the adhesive panel further includes a tear strip disposed between the primary adhesive and the secondary adhesive, the tear strip configured to be torn from the adhesive panel to remove the primary adhesive from the adhesive panel.

6. The folding blank of claim 1, wherein each of the first outer lid wing panel and the second outer lid wing panel has an outer edge, the outer edge of the first outer lid wing panel corresponds to and abuts the outer edge of the second outer lid wing panel where the first outer lid wing panel and the second outer lid wing panel are in the folded position.

7. The folding blank of claim 1, wherein the outer edge of each of the first outer lid wing panel and the second outer lid wing panel is serpentine.

8. The folding blank of claim 1, wherein the main body further includes an inner lid disposed opposite the outer lid and configured to selectively move between an opened position and a closed position where the remainder of the folding blank has been folded into a box, and wherein the outer surface of the inner lid is visible where the inner lid is in a closed position and the outer lid is in the opened position.

9. The folding blank of claim 8, wherein the inner lid has an inner lid panel with a finger aperture formed therein and configured to permit a gripping of the inner lid where in the closed position to move the inner lid from the closed position to the opened position.

10. The folding blank of claim 9, wherein the inner lid includes a free edge, and wherein a central portion of the free edge defines the finger aperture.

11. The folding blank of claim 8, wherein the inner lid includes a first inner lid wing panel and a second inner lid wing panel, each of the first inner lid wing panel and the second inner lid wing panel configured to be folded inwardly and not be visible where the inner lid is in the closed position, and wherein each of the first inner lid wing and the second inner lid wing is further configured to be visible where the inner lid is in the opened position.

12. The folding blank of claim 9, wherein the inner lid includes a free end panel is configured to fold inwardly and not be visible where the inner lid is in the closed position, and wherein the free end panel is further configured to be visible where the inner lid is in the opened position, and wherein the finger aperture is disposed between the inner lid panel and the free end panel.

13. A mailer, comprising:
a folding blank that has been folded into a box, the folding blank including a main body having an inner surface and an outer surface, the inner surface having no printing thereon, and the outer surface having printing thereon, the main body further including an outer lid configured to selectively move between an opened position and a closed position, the outer lid having an outer lid panel, a first outer lid wing panel, and a second outer lid wing panel, each of the first outer lid wing panel and the second outer lid wing panel folded inwardly from an unfolded position to a folded position so that the inner surface of the first outer lid wing panel and the inner surface of the second outer lid wing panel are disposed adjacent to and facing the inner surface of the outer lid panel in the folded position,
wherein the outer surface of each of the first outer lid wing panel and the outer surface of the second outer lid wing panel is visible where the outer lid is in the opened position.

14. The folding blank of claim 13, wherein both the inner surface of the first outer lid wing panel and the inner surface of the second outer lid wing panel are affixed to the outer lid panel via an adhesive.

15. The folding blank of claim 13, wherein the outer lid further includes an adhesive panel, the inner surface of the adhesive panel having a primary adhesive configured to affix the outer lid to a portion of the box where the outer lid is in the closed position.

16. The folding blank of claim 13, wherein the main body further includes an inner lid disposed opposite the outer lid and configured to selectively move between an opened position and a closed position, and wherein the outer surface of the inner lid is visible where the inner lid is in a closed position and the outer lid is in the opened position.

17. A method for constructing a mailer, the method comprising the steps of:
providing the folding blank with a main body having an inner surface and an outer surface, the inner surface having no printing thereon, and the outer surface having printing thereon, the main body further including an outer lid configured to selectively move between an opened position and a closed position where a remainder of the folding blank has been folded into a box, the outer lid having an outer lid panel, a first outer lid wing panel, and a second outer lid wing panel, each of the first outer lid wing panel and the second outer lid wing panel configured to fold inwardly from an unfolded position to a folded position so that the inner surface of the first outer lid wing panel and the inner surface of the second outer lid wing panel are disposed adjacent to and facing the inner surface of the outer lid panel in the folded position;
folding the first outer lid wing panel and the second outer lid wing panel inwardly from the unfolded position to the folded position; and
folding the remainder of the folding blank to form a box, wherein the outer surface of each of the first outer lid wing panel and the outer surface of the second outer lid wing panel are visible where the outer lid is in the opened position.

18. The method of claim 17, further including a step of applying an adhesive to at least one of the inner surface of the first outer lid wing panel, the inner surface of the second outer lid wing panel, and the outer lid panel, prior to the step of folding the first outer lid wing panel and the second outer lid wing panel.

19. The method of claim 17, wherein the outer lid further includes an adhesive panel, the inner surface of the adhesive panel having a primary adhesive, and wherein the method further includes a step of moving the outer lid to the closed position so that the primary adhesive abuts a portion of the box, thereby affixing the outer lid to the portion of box.

20. The folding blank of claim 13, wherein the main body further includes an inner lid disposed opposite the outer lid and configured to selectively move between an opened position and a closed position, and wherein the method further includes a step of moving the inner lid to the closed position prior to the step of moving the outer lid to the closed position.
